(19) United States
(12) Patent Application Publication
(10) Pub. No.: US 2025/0027653 A1
(43) Pub. Date: Jan. 23, 2025

(54) COOKING APPLIANCE WITH ACCELERATED PRE-HEATING OF OVEN CAVITY

(71) Applicant: WHIRLPOOL CORPORATION, BENTON HARBOR, MI (US)

(72) Inventors: Joseph Gerald Yanos, Kalamazoo, MI (US); David Vehslage, Baroda, MI (US); Joel Fletty, Stevensville, MI (US); Traci Lee Kachorek, St. Joseph, MI (US); Avery Josephine Saylor, St. Joseph, MI (US); Michael Charles Allen, St. Joseph, MI (US); Keila Mara Borsari Luiz De Araujo, Saint Joseph, MI (US)

(73) Assignee: WHIRLPOOL CORPORATION, BENTON HARBOR, MI (US)

(21) Appl. No.: 18/223,818

(22) Filed: Jul. 19, 2023

(51) Int. Cl. F24C 7/08; H05B 6/64

(52) U.S. Cl. CPC F24C 7/085; H05B 6/6473

(57) ABSTRACT

A cooking appliance including: (a) an oven liner at least partially defining an oven cavity; (b) a first heating element positioned to increase temperature of air within the oven cavity; (c) a second heating element, separate from the first heating element, positioned to increase the temperature of the air within the oven cavity; (d) another cooking area outside of the oven cavity; (e) a third heating element positioned to generate heat at the other cooking area; and (f) a controller in communication with the first heating element, the second heating element, and the third heating element, the controller configured (i) to activate both the first heating element and the second heating element to generate heat simultaneously during an accelerated preheating operation to preheat the oven cavity and (ii) subsequently to deactivate either the first heating element or the second heating element after the third heating element is commanded to activate.

### TECHNICAL FIELD

This disclosure pertains to cooking appliances, and more particularly, to cooking appliances with accelerated pre-heating functionality.

### BACKGROUND

A cooking appliance sometimes offers more than one cooking technique. For example, a free-standing range variety of a cooking appliance typically offers both (i) a cooktop with associated heating elements at a top of the free-standing range and (ii) an oven cavity with a baking heating element dedicated to baking and a broiling heating element, which is separate from the baking heating element, dedicated to broiling. Many recipes instruct a user to preheat the oven cavity to a predetermined temperature for baking or reheating before a food item is placed in the cavity.

However, there is a problem in that preheating the oven takes a period of time that is longer than the user might desire. To address that problem, some cooking appliances offer a boost preheat mode where several heating elements in thermal communication with the oven cavity are simultaneously activated to preheat the oven cavity more quickly. However, those cooking appliances present an additional problem in that the heating elements associated with the cooktop are deactivated during the boost preheat mode—that is, the user is prevented from utilizing any of the heating elements associated with the cooktop. That is a problem because the user might desire to use one or more of the heating elements associated with the cooktop even after the boost preheat mode begins, which frustrates the user.

### SUMMARY

The present disclosure addresses that problem with a cooking appliance that does not prevent the user from activating a heating element unassociated with the oven cavity (e.g., at a cooktop) during an accelerated preheating operation. Absent the user commanding the activation of the heating element unassociated with oven cavity, the cooking oven activates several distinct heating elements associated with the oven cavity for an accelerated preheating operation. In the event that the user commands activation of the heating element unassociated with the oven cavity, the cooking appliance deactivates one of the heating elements associated with the oven cavity to transition from the accelerated preheating operation to a non-accelerated preheating operation. The non-accelerated preheating operation occurs simultaneously with the user utilizing the heating element unassociated with the oven cavity.

In a first aspect of the present disclosure, a cooking appliance comprises: (a) an oven liner at least partially defining an oven cavity; (b) a first heating element positioned to increase the temperature of air within the oven cavity; (c) a second heating element, separate from the first heating element, positioned to increase the temperature of the air within the oven cavity; (d) another cooking area outside of the oven cavity; (e) a third heating element positioned to generate heat at the other cooking area; and (f) a controller in communication with the first heating element, the second heating element, and the third heating element, the controller configured (i) to activate both the first heating element and the second heating element, such that the first heating element and the second heating element generate heat simultaneously, during an accelerated preheating operation to preheat the air within the oven cavity and (ii) subsequently to deactivate one of the first heating element and the second heating element, while maintaining activation of the other of the first heating element and second heating element, after the third heating element is commanded to activate.

According to another aspect of the present disclosure, a method of operating a cooking appliance comprises: (a) preheating an oven cavity of a cooking appliance with both a first heating element and a second heating element of a cooking appliance generating heat simultaneously and increasing temperature of air within the oven cavity of the cooking appliance; and (b) deactivating one of the first heating element and the second heating element, while maintaining activation of the other of the first heating element and the second heating element to continue to preheat the oven cavity, after a third heating element of the cooking appliance has been commanded to activate, wherein, the third heating element is positioned to generate heat at another cooking area of the cooking appliance outside of the oven cavity.

### BRIEF DESCRIPTION OF THE DRAWINGS

In the Drawings:

FIG. 1 is a perspective view of a cooking appliance of the present disclosure, illustrating an oven cavity and several other cooking areas including a cooktop and a second oven cavity;

FIG. 2 is a front elevation view of the cooking appliance of FIG. 1, illustrating the cooking appliance further including a human-machine interface;

FIG. 3 is a magnified view of an oven liner of the cooking appliance of FIG. 1 that defines the oven cavity, illustrating the cooking appliance further including a first heating element and a second heating element;

FIG. 4 is an overhead view of the cooktop as another cooking area of the cooking appliance of FIG. 1, illustrating the cooktop including a third heating element;

FIG. 5 is a magnified view of the second oven liner as another cooking area of the cooking appliance of FIG. 1, illustrating the cooking appliance further including a third heating element as either a broil heating element or a bake heating element;

FIG. 6 is a schematic view of a controller of the cooking appliance of FIG. 1, illustrating the controller in communication with the human-machine interface, the first heating element, the second heating element, and the third heating element; and

FIG. 7 is a flow diagram of a method of operating the cooking appliance of FIG. 1, illustrating steps of (i) preheating the oven cavity with both the first heating element and the second heating element generating heat simultaneously and increasing the temperature of the air within the oven cavity for an accelerated preheating operation and (ii) deactivating one of the first heating element and the second heating element, after the user has commanded the third heating element to be activated, to transition to a non-accelerated preheating operation instead.

### DETAILED DESCRIPTION

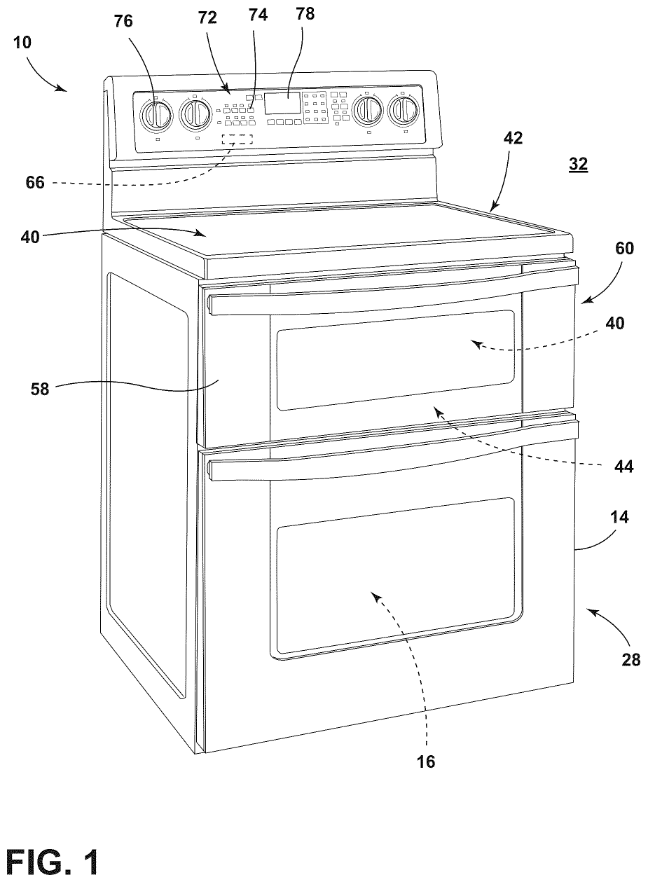

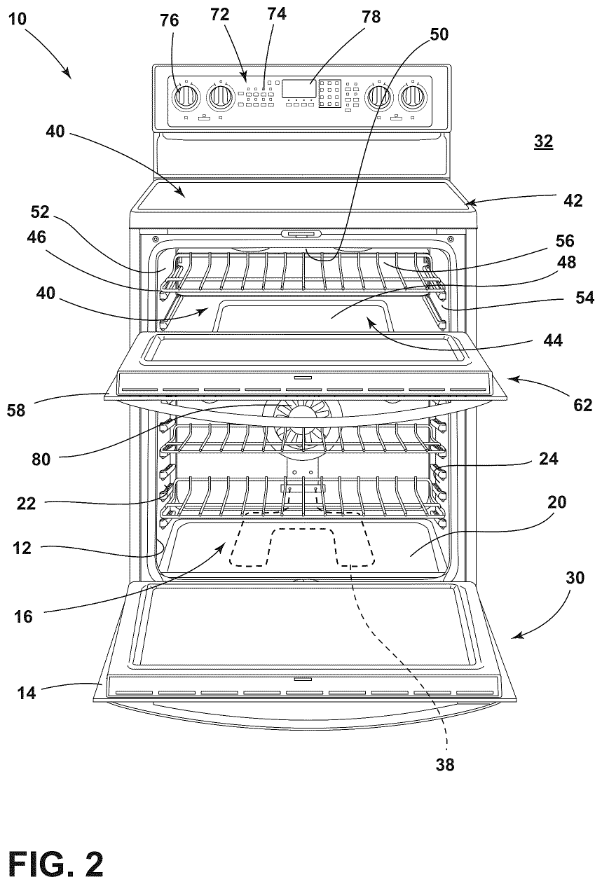

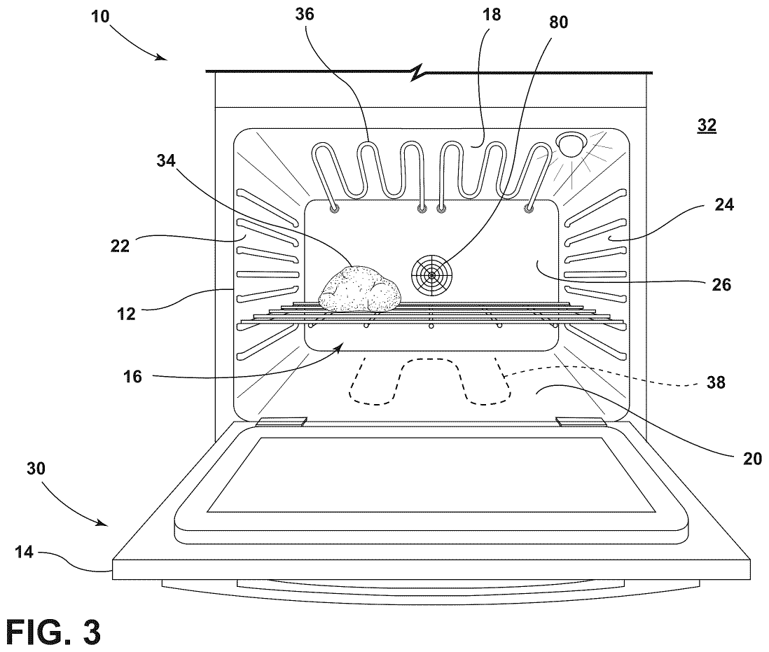

Referring to FIGS. 1-3, a cooking appliance 10 includes an oven liner 12 and a door 14. The oven liner 12 at least partially defines an oven cavity 16. For example, the oven liner 12 can include a ceiling 18, a floor 20 opposing the ceiling 18, opposing side walls 22, 24, and a rear wall 26. The ceiling 18, the floor 20, the opposing side walls 22, 24, and the rear wall 26 at least partially define the oven cavity 16. The oven liner 12 can be formed of metal, such as stainless steel, or other materials such as ceramic and porcelain enamel. The door 14 is manipulable to, from, and between a closed position 28 (see, e.g., FIG. 1) and an open position 30 (see, e.g., FIGS. 2-3). In the closed position 28, the door 14 denies access to the oven cavity 16 from an external environment 32. In the open position 30, the door 14 allows access to the oven cavity 16 from the external environment 32. The cooking appliance 10 can be a freestanding range, as illustrated, or can be a built-in oven that is partially recessed behind cabinetry. In use, after preheating of the oven cavity 16, a food item 34 is placed within the oven cavity 16 and the cooking appliance 10 raises a temperature of the food item 34, sometimes to trigger various chemical reactions to alter the composition, structure, and flavor of the food item 34 (e.g., denaturation of proteins, caramelization, reduction of fat, and so on).

The cooking appliance 10 further includes a first heating element 36 and a second heating element 38 both positioned to increase the temperature of air within the oven cavity 16. In embodiments, the first heating element 36 is at least partially exposed within the oven cavity 16 near the ceiling 18 of the oven liner 12. The first heating element 36 in such a position is disposed over the food item 34 within the oven cavity 16. The first heating element 36 can be utilized to perform a broiling operation on the food item 34. The first heating element 36 is an electric heating element and generates heat via electrical resistance.

The second heating element 38 is separate from the first heating element 36. In embodiments, such as those illustrated, the second heating element 38 is positioned beneath the floor 20 of the oven liner 12. In other embodiments, the second heating element 38 is at least partially exposed within the oven cavity 16 near the floor 20 of the oven liner 12, such as just above the floor 20. The second heating element 38 thus can be disposed elevationally below the food item 34 placed within the oven cavity 16. The second heating element 38 can be utilized to perform a baking operation on the food item 34. In other embodiments, the second heating element 38 is positioned to provide convection heating. The second heating element 38, like the first heating element 36, is an electric heating element and generates heat via electrical resistance. The first heating element 36 and the second heating element 38 can be any combination of heating elements positioned to increase the temperature of air within the oven cavity 16 (e.g., baking heating element and broiling heating element, broiling heating element and convection heating element, and so on), and the appliance 10 can include more heating elements in addition to the first heating element 36 and the second heating element 38 positioned to increase the temperature of air within the oven cavity 16 (e.g., all of a baking heating element, a broiling heating element, and a convection heating element).

The cooking appliance 10 further includes another cooking area 40 outside of the oven cavity 16. In the illustrated embodiments, the cooking appliance 10 has two other cooking areas outside 40 of the oven cavity 16. Those other cooking areas 40 include (i) a cooktop 42 providing the other cooking area 40 and (ii) a second oven cavity 44 providing the other cooking area 40. The cooktop 42, which may alternatively be referred to as a stovetop or a range, is disposed above the oven cavity 16. The cooktop 42 allows for cooking operations such as boiling, simmering, sauteing, frying, and so on. The second oven cavity 44 is illustrated as being above the oven cavity 16 but alternatively could be below the oven cavity 16. The cooking appliance 10, in the illustrated embodiments, includes a second oven liner 46 that at least partially defines the second oven cavity 44. The second oven liner 46, like the oven liner 12, can include a floor 48, a ceiling 50 opposing the floor 48, opposing side walls 52, 54, and a rear wall 56, collectively at least partially defining the second oven cavity 44. In such embodiments with a second oven cavity 44, the cooking appliance 10 further includes a second door 58. Like the door 14, the second door 58 is manipulable to, from, and between a closed position 60 (see FIG. 1) and an open position 62 (see FIG. 2). In the closed position 60, the second door 58 denies access to the second oven cavity 44 from the external environment 32. In the open position 62, the second door 58 allows access to the second oven cavity 44 from the external environment 32.

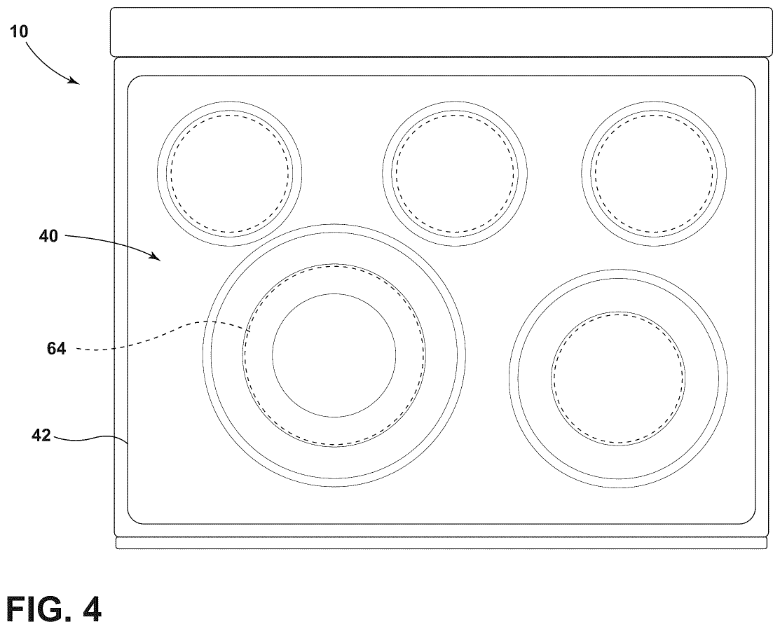

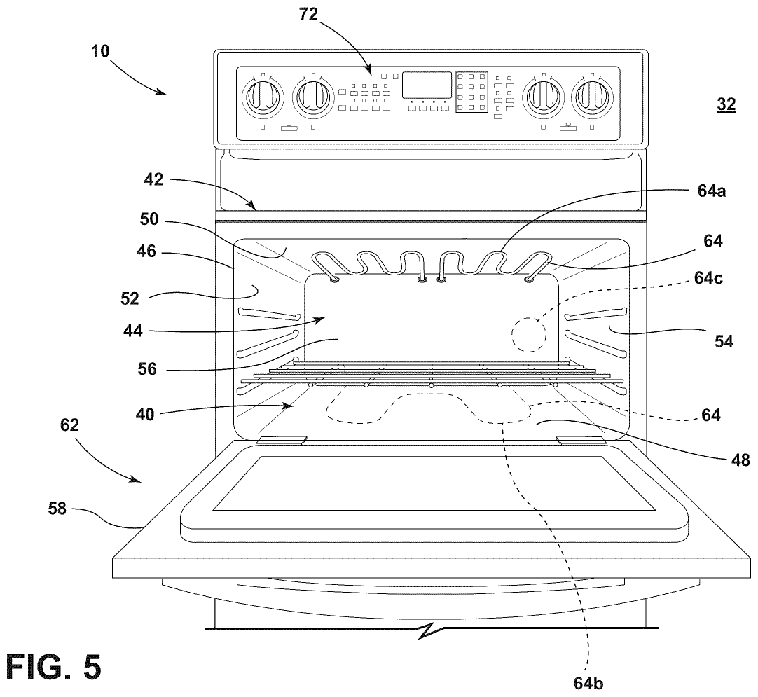

Referring additionally to FIGS. 4 and 5, the cooking appliance 10 further includes a third heating element 64 to generate heat at the other cooking area 40. The third heating element 64 is an electric heating element. In embodiments, such as those illustrated where the cooktop 42 is the other cooking area 40, the cooktop 42 includes the third heating element 64. For example, the third heating element 64 can be an inductive heating element, which generates heat at the cooktop 42 by generating a rapidly changing magnetic field that causes eddy currents within a ferromagnetic cooking vessel, which the vessel resists thus generating heat. As another example, the third heating element 64 can be a radiant element made of glass-ceramic or some other suitable material that generates heat via electrical resistance. As still another example, the third heating element 64 can be an electrical coil that also generates heat via electrical resistance.

In embodiments, such as those illustrated where the second oven cavity 44 is the other cooking area 40, the third heating element 64 is positioned to increase the temperature of air or a food item 34 disposed within the second oven cavity 44. For example, the third heating element 64 can be a broil heating element 64a disposed at the ceiling 50 of the second oven liner 46 and open to the second oven cavity 44. The broil heating element 64a generates heat via electrical resistance. As another example, the third heating element 64 can be a bake heating element 64b disposed at or below the floor 20 of the second oven liner 46. The bake heating element 64b generates heat via electrical resistance. As still another example, the third heating element 64 can be a magnetron 64c. The magnetron 64c generates microwaves that cause water molecules within the food item 34 to vibrate and thus generate heat. As yet another example, the third heating element 64 can be a heating element used for convection heating within the second oven cavity 44. In any case, when associated with the second oven cavity 44, the third heating element 64 is positioned to increase temperature of the air or the food item 34 within the second oven cavity 44.

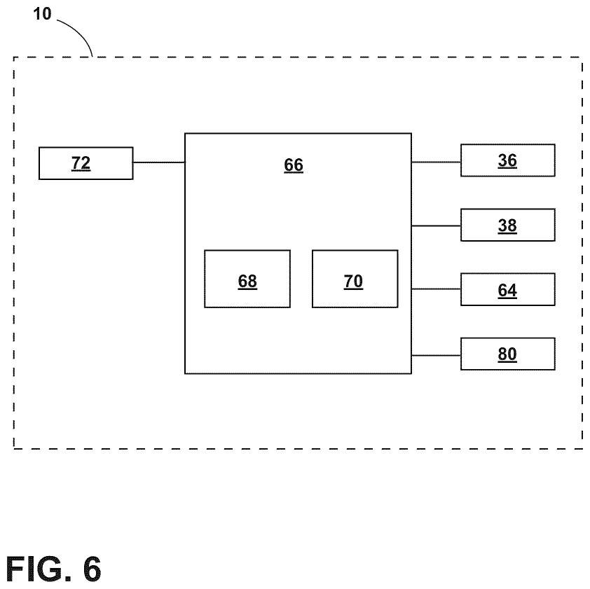

Referring now additionally to FIG. 6, the cooking appliance 10 further includes a controller 66. The controller 66 is configured to perform the functions herein described. The controller 66 can include memory 68 and a processor 70. The memory 68 can store operations for the controller 66 to perform the functions herein described. The memory 68 can include random access memory, volatile memory, non-volatile memory, dynamic random access memory, flash memory, cache memory, a hard drive, an optical drive, a tape drive, or any other device capable of storing information either temporarily or persistently. The processor 70 can include one or more microprocessors, micro-controllers, digital signal processors, microcomputers, central processing units, graphical processing units, tensor processing units, field programmable gate arrays, programmable logic devices, state machines, logic circuits, analog circuits, digital circuits, or any other devices that manipulate signals (analog or digital) based on computer-executable instructions residing in memory 68. The processor 70 can be configured to read into memory 68 and execute computer-executable instructions residing in memory 68. Upon execution by the processor 70, the computer-executable instructions may cause the cooking appliance 10 to implement one or more of the methodologies disclosed herein.

The controller 66 is in communication with the first heating element 36, the second heating element 38, and the third heating element 64.

The controller 66 is configured to activate both the first heating element 36 and the second heating element 38, such that the first heating element 36 and the second heating element 38 generate heat simultaneously, during an accelerated preheating operation to preheat the air within the oven cavity 16. For example, the cooking appliance 10 can include a human-machine interface 72. The human-machine interface 72 is accessible to a user from the external environment 32. The human-machine interface 72 can include one or more buttons 74 (physical or touch screen), switches, or knobs 76 that allows a user to command (i) a cooking operation (e.g., a baking operation, a broiling operation, a convection cooking operation, and so on) and (ii) a temperature at which the cooking operation is to occur. In embodiments, upon selection of the temperature, the controller 66 causes the accelerated preheating operation to commence and activates both the first heating element 36 and the second heating element 38. In other words, in those embodiments, upon receiving the temperature selection from the human-machine interface 72 for the cooking operation, the controller 66 activates both the first heating element 36 and the second heating element 38 for the accelerated preheating operation, without the user having to command separately the accelerated preheating operation. In other embodiments, after setting the temperature for the cooking operation, the user commands at the human-machine interface 72 (via one of the buttons 74 or otherwise) that the accelerated preheating operation is to occur, after which the controller 66 activates both the first heating element 36 and the second heating element 38 for the accelerated preheating operation. The controller 66 activates both the first heating element 36 and the second heating element 38 only if the third heating element 64 is not activated.

The controller 66 does not lock the user out of activating the third heating element 64 during the accelerated preheating operation with the first heating element 36 and the second heating element 38 both activated. The user can manipulate the human-machine interface 72 to command activation of the third heating element 64 such as by turning one of the knobs 76 or pressing one of the buttons 74. For example, if the user desires to activate the third heating element 64 at the cooktop 42, the user might turn one of the knobs 76 at the human-machine interface 72 associated with the third heating element 64 at the cooktop 42. The turning of the knob 76 (or other form of commanding activation) can close the electrical circuit powering the third heating element 64 without the controller 66 actively powering the third heating element 64. As another example, if the user desires to activate the third heating element 64 to heat the second oven cavity 44, the user might push one of the buttons 74 at the human-machine interface 72 designated to initiate baking within the second oven cavity 44 and select a temperature at which the baking in the second oven cavity 44 is to occur. Although the controller 66 has activated both the first heating element 36 and the second heating element 38 for the accelerated preheating operation, the controller 66 allows the user to activate the third heating element 64 before the accelerated preheating operation has been completed.

However, after the user commands the activation of the third heating element 64, the controller 66 is configured to deactivate subsequently one of the first heating element 36 and the second heating element 38, while maintaining activation of the other of the first heating element 36 and the second heating element 38. For example, after the controller 66 receives input from the human-machine interface 72 that the user has commanded activation of the third heating element 64, the controller 66 deactivates the first heating element 36 while maintaining activation of the second heating element 38. As another example, after the controller 66 receives input from the human-machine interface 72 that the user has commanded activation of the third heating element 64, the controller 66 deactivates the second heating element 38 while maintaining activation of the first heating element 36.

In some embodiments, the third heating element 64 is activated for a brief period of time (e.g., less that 5 seconds, less than 2 seconds, or less than 1 second) before the controller 66 deactivates either the first heating element 36 or the second heating element 38. The input upon which the controller 66 relies could be that the electrical circuit powering the third heating element 64 has been closed (e.g., current is flowing to the third heating element 64 as a result of the user turning the knob 76). In such instances, the first heating element 36, the second heating element 38, and third heating element 64 may all be activated for a brief period of time (insufficient to trip a circuit breaker) before the controller deactivates one of the first heating element 36 and the second heating element 38.

In other embodiments, the controller 66 is further configured to activate the third heating element 64, after deactivating one of the first heating element 36 and the second element, in response to the user command. In other words, in these embodiments, the controller 66 deactivates the first heating element 36 or the second heating element 38 before activating the third heating element 64. In such embodiments, the controller 66 in not just in communication with the third heating element 64 but controls the activation and deactivation thereof.

In any event, the controller 66 then maintains activation of whichever of the first heating element 36 or the second heating element 38 was not deactivated as a non-accelerated preheating operation. In short, the controller 66, in response to the user commanding activation of the third heating element 64, changes from the accelerated preheating operation (with both the first heating element 36 and the second heating element 38 activated) to the non-accelerated preheating operation to continue to preheat the air within the oven cavity 16 (with only the first heating element 36 or the second heating element 38 activated).

In embodiments, the human-machine interface 72 includes a display 78 that is visible to the user at the external environment 32. The controller 66 can be further configured to cause the display 78 to display a period of time remaining until completion of the accelerated preheating operation. For example, assuming that the third heating element 64 is not activated, after the user selects the bake operation and sets the temperature, the controller 66 can activate both the first heating element 36 and the second heating element 38 as well as cause the display 78 to display the period of time remaining until completion of the accelerated preheating operation. However, in response to the user commanding the third heating element 64 to activate, the controller 66 is further configured to cause the display 78 to display a second period of time remaining until completion of the non-accelerated preheating operation. The second period of time is greater than the first period of time. For example, just before the user commands activation of the third heating element 64, the display 78 can display “7:00” (that being 7 minutes) as the period of time remaining for the accelerated preheating operation, but after the user commands activation of the third heating element 64, the controller 66 can cause the display 78 to display “10:00” (10 minutes) as the period of time remaining for the non-accelerated preheating operation. In short, the deactivation of either the first heating element 36 or the second heating element 38 in response to the user commanding activation of the third heating element 64 increases the amount of time required to preheat the air in the oven cavity 16 to the temperature that the user has commanded. That is because the first heating element 36 or the second heating element 38 alone generates less heat than both the first heating element 36 and the second heating element 38 combined.

In embodiments, the cooking appliance 10 has a power rating. The power rating is not a physical component of the cooking appliance 10. Rather, the power rating indicates a maximum amount of electrical power that the cooking appliance 10 is designed to consume during use. For example, the typical cooking appliance 10 might have a power rating of 7,200 W. The cooking appliance 10 does not exceed the power rating during the accelerated preheating operation with both the first heating element 36 and the second heating element 38 activated. For example, the first heating element 36 (e.g., the broil heating element 64a) may generate 3,400 W and the second heating element 38 (e.g., the bake heating element 64b) may generate 2,400 W, for a combined generation of 5,800 W, which is less than the power rating of 7,200 W. However, in embodiments, the cooking appliance 10 would exceed the power rating if the third heating element 64 were activated simultaneously (for more than a short period of time) with the first heating element 36 and the second heating element 38 during the accelerated preheating operation. For example, the third heating element 64 (e.g., a heating element at the cooktop 42) may generate 1,680 W. Combined, the first heating element 36, the second heating element 38, and the third heating element 64 would generate 7,480 W, which exceeds the power rating of the cooking appliance 10 of 7,200 W. The controller 66 deactivating either the first heating element 36 or the second heating element 38 upon receiving the user command to activate the third heating element 64 allows the cooking appliance 10 to remain under the power rating during the remainder of the non-accelerated preheating operation. For example, the first heating element 36 at 3,400 W can be utilized for the non-accelerated preheating operation along with the third heating element 64 at 1,680 W for a combined 5,080 W generation, which is under the power rating of 7,200 W.

In embodiments, the cooking appliance 10 has a maximum amount of electrical current (hereinafter “current”) that the cooking appliance 10 will permit. For example, the cooking appliance 10 can have a current limiter. A hypothetical current limiter might limit current flowing through the cooking appliance 10 at 30 A. In addition, residential circuits in the United States are designed to accommodate up to 40 A. In some instances, while both the first heating element 36 and the second heating element 38 are activated for the accelerated preheating operation, the first heating element 36 and the second heating element 38 combined encounter a current that is greater than 24 A but less than 40 A. The current that the first heating element 36 and the second heating element 38 combined encounter is additionally less than the maximum current that the current limiter allows (e.g., 30 A). In some instances, if the controller 66 were to activate all of the first heating element 36, the second heating element 38, and the third element simultaneously (for more than a brief period of time), the combined current would exceed the maximum current that the current limiter allows. In some instances, if the controller 66 were to activate all of the first heating element 36, the second heating element 38, and the third element simultaneously (for more than a brief period of time), the combined current would exceed the 40 A limitation of the residential circuit. The controller 66 activating either the first heating element 36 or the second heating element 38 for the non-accelerated preheating operation, in addition to the third heating element 64 would not cause the cooking appliance 10 to encounter a combined current that exceeds the maximum current that the current limiter allows or the 40 A limitation of the residential circuit.

The first heating element 36 and the second heating element 38 may encounter different current during the accelerated preheating operation. For example, the first heating element 36 may encounter a current that is greater than the current that the second heating element 38 encounters. For instance, the first heating element 36 as a broil heating element 64a may encounter 14 A to 15 A, while the second heating element 38 as the bake heating element 64b may encounter 10 A.

In embodiments, the cooking appliance 10 further includes a fan 80. The fan 80 is positioned to move air within the oven cavity 16. For example, as in the illustrated embodiments, the fan 80 can be positioned at the rear wall 26 of the oven liner 12. The controller 66 is in communication with the fan 80 and thus can activate and deactivate the fan 80. In embodiments, during the accelerated preheating operation, the controller 66 is further configured to activate simultaneously all of the first heating element 36, the second heating element 38, and the fan 80. The cooking appliance 10 can additionally activate the fan 80 during the accelerated preheating operation, because the fan 80 draws relatively low power and experiences relatively low current (e.g., less than 60 W at less than 1 A) compared to the first heating element 36 and the second heating element 38. In the event that the user commands activation of the third heating element 64, and the controller 66 thus deactivates one of the first heating element 36 or the second heating element 38, the controller 66 can maintain activation of the third heating element 64 during the remainder of the non-accelerated preheating operation. The fan 80 moving air within the oven cavity 16 helps reduce the intensity of thermal gradients within the oven cavity 16 during the accelerated preheating operation and the non-accelerated preheating operation.

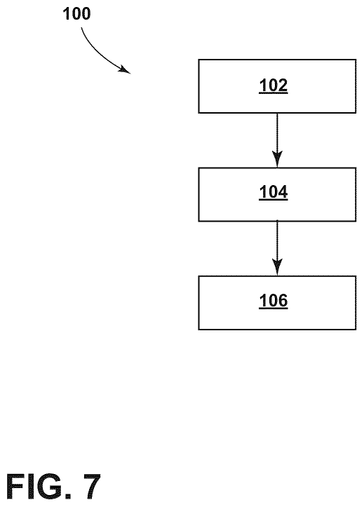

Referring now to FIG. 7, a method 100 of operating the cooking appliance 10 is herein described. At a step 102, the method 100 includes preheating the oven cavity 16 with both the first heating element 36 and the second heating element 38 generating heat simultaneously and increasing the temperature of the air within the oven cavity 16. As discussed above, the controller 66 can be configured with suitable computer readable instructions in memory 68 to activate both the first heating element 36 and the second heating element 38 upon receiving input from the human-machine interface 72 that the user has commanded a cooking operation and set the temperature at which cooking is to occur. The controller 66 can be configured to do so only if the controller 66 has not activated the third heating element 64.

At a step 104, the method 100 further includes deactivating one of the first heating element 36 and the second heating element 38 after the user has commanded the third heating element 64 to be activated. The controller 66 can be configured to perform the step 104 with suitable computer readable instructions in memory 68. Upon receiving input from the human-machine interface 72 that the third heating element 64 has been commanded to be activated, the controller 66 can deactivate either the first heating element 36 or the second heating element 38.

At a step 106, the method 100 further includes activating the third heating element 64. The controller 66 maintains activation of the other of the first heating element 36 and the second heating element 38 that the controller 66 has not deactivated for the remainder of the non-accelerated preheating operation. The controller 66 can be configured to perform the step 106 with suitable computer readable instructions in memory 68. Upon receiving input from the human-machine interface 72 that the third heating element 64 has been commanded to be activated, the controller 66 can activate the third heating element 64.

The present disclosure addresses the problem outlined in the background, because the cooking appliance 10 does not prevent the user from activating the third heating element 64 not associated with the oven cavity 16 (e.g., a cooktop 42 heating element) during the accelerated preheating operation. Rather, the cooking appliance 10 recognizes that the user has commanded activation of the third heating element 64 and then deactivates either the first heating element 36 or the second heating element 38, thus ending the accelerated preheating operation, but maintains activation of the other of the first heating element 36 and the second heating element 38 to continue with a non-accelerated preheating operation. Accordingly, the cooking appliance 10 still preheats the oven cavity 16 in a non-accelerated fashion, while allowing the user to utilize the third heating element 64 to perform a cooking operation at the cooktop 42 or the second oven cavity 44. Thus, the user is not frustrated with being locked out of using the third heating element 64 during preheating. During the occasions where the user does not desire to use the third heating element 64, then the cooking appliance 10 preheats the oven cavity 16 in an accelerated fashion using both the first heating element 36 and the second heating element 38, which the user finds acceptable because the preheating is accelerated.

According to a first aspect of the present disclosure, a cooking appliance comprises: (a) an oven liner at least partially defining an oven cavity; (b) a first heating element positioned to increase temperature of air within the oven cavity; (c) a second heating element, separate from the first heating element, positioned to increase the temperature of the air within the oven cavity; (d) another cooking area outside of the oven cavity; (e) a third heating element positioned to generate heat at the other cooking area; and (f) a controller in communication with the first heating element, the second heating element, and the third heating element, the controller configured (i) to activate both the first heating element and the second heating element, such that first heating element and the second heating element generate heat simultaneously, during an accelerated preheating operation to preheat the air within the oven cavity and (ii) subsequently to deactivate one of the first heating element and the second heating element, while maintaining activation of the other of the first heating element and second heating element, after the third heating element is commanded to activate.

According to a second aspect of the present disclosure, the cooking appliance of the first aspect is presented, wherein the first heating element is at least partially exposed within the oven cavity near a ceiling of the oven liner.

According to a third aspect of the present disclosure, the cooking appliance of any one of the first through second aspects is presented, wherein the second heating element is either (i) at least partially exposed within the oven cavity near a floor of the oven liner or (ii) disposed beneath the floor of the oven liner.

According to a fourth aspect of the present disclosure, the cooking appliance of any one of the first through third aspects is presented further comprises a cooktop as the other cooking area, the cooktop comprising the third heating element.

According to a fifth aspect of the present disclosure, the cooking appliance of any one of the first through third aspects further comprises a second oven liner at least partially defining a second oven cavity as the other cooking area, wherein, the third heating element is positioned to increase temperature of air within the second oven cavity.

According to a sixth aspect of the present disclosure, the cooking appliance of any one of the first through third aspects is presented, wherein the third heating element is a magnetron.

According to a seventh aspect of the present disclosure, the cooking appliance of any one of the first through sixth aspects is presented, wherein the controller activates both the first heating element and the second heating element for the accelerated preheating operation, upon a user issuing a command for a cooking operation and setting a temperature for the cooking operation, without the user having to command separately the accelerated preheating operation.

According to an eighth aspect of the present disclosure, the cooking appliance of any one of the first through seventh aspects is presented, wherein the third heating element is activated for a brief period of time before the controller deactivates one of the first heating element and the second heating element.

According to a ninth aspect of the present disclosure, the cooking appliance of any one of the first through eighth aspects is presented, wherein the controller is further configured to activate the third heating element after deactivating one of the first heating element and the second heating element.

According to a tenth aspect of the present disclosure, the cooking appliance of any one of the first through ninth aspects is presented, wherein the controller is further configured to activate only one of the first heating element and the second heating element during a non-accelerated preheating operation to preheat the air within the oven cavity.

According to an eleventh aspect of the present disclosure, the cooking appliance of any one of the first through tenth aspects further comprises a human-machine interface at which a user of the cooking appliance can command activation of the third heating element, wherein, the controller is further in communication with the human-machine interface.

According to a twelfth aspect of the present disclosure, the cooking appliance of the eleventh aspect is presented, wherein (i) the human-machine interface includes a display that is visible to a user, and (ii) the controller is further configured to cause the display to display a first period of time remaining until completion of the accelerated preheating operation.

According to a thirteenth aspect of the present disclosure, the cooking appliance of the twelfth aspect is presented, wherein in response to the third heating element being commanded to activate, the controller is further configured to cause the display to display a second period of time remaining until completion of a non-accelerated preheating operation to preheat the air within the oven cavity, the second period of time being greater than the first period of time.

According to a fourteenth aspect of the present disclosure, the cooking appliance of any one of the first through thirteenth aspects is presented, wherein (i) the cooking appliance has a power rating indicating a maximum amount of electrical power the cooking appliance is designed to consume during use, and (ii) the cooking appliance does not exceed the power rating during the accelerated preheating operation but would exceed the power rating if the third heating element were activated simultaneously with the first heating element and the second heating element during the accelerated preheating operation.

According to a fifteenth aspect of the present disclosure, the controller activates both the first heating element and the second heating element for the accelerated preheating operation, upon a user issuing a command for a cooking operation and setting a temperature for the cooking operation and upon the user issuing a command for the accelerated preheating operation.

According to a sixteenth aspect of the present disclosure, the cooking appliance of any one of the first through fifteenth aspects is presented, wherein while both the first heating element and the second heating element are activated, the first heating element encounters an electrical current that is greater than an electrical current that the second heating element encounters.

According to a seventeenth aspect of the present disclosure, the cooking appliance of any one of the first through sixteenth aspects further comprises a fan positioned to move the air within the oven cavity, wherein (i) the controller is in further communication with the fan, and (ii) the controller is further configured to activate simultaneously all of the first heating element, the second heating element, and the fan during the accelerated preheating operation.

According to an eighteenth aspect of the present disclosure, the cooking appliance of any one of the first through seventeenth aspects is presented, wherein the controller does not lock a user out of activating the third heating element during the accelerated preheating operation.

According to a nineteenth aspect of the present disclosure, a method of operating a cooking appliance comprises: (i) preheating an oven cavity of a cooking appliance with both a first heating element and a second heating element of a cooking appliance generating heat simultaneously and increasing temperature of air within the oven cavity of the cooking appliance; and (ii) deactivating one of the first heating element and the second heating element, while maintaining activation of the other of the first heating element and the second heating element to continue to preheat the oven cavity, after a third heating element of the cooking appliance has been commanded to activate, wherein, the third heating element is positioned to generate heat at another cooking area of the cooking appliance outside of the oven cavity.

According to a twentieth aspect of the present disclosure, the method of the nineteenth aspect further comprises activating the third heating element while maintaining activation of the other of the first heating element and the second heating element to continue to preheat the oven cavity.

What is claimed is:

1. A cooking appliance comprising:
an oven liner at least partially defining an oven cavity;
a first heating element positioned to increase temperature of air within the oven cavity;
a second heating element, separate from the first heating element, positioned to increase the temperature of the air within the oven cavity;
another cooking area outside of the oven cavity;
a third heating element positioned to generate heat at the other cooking area; and
a controller in communication with the first heating element, the second heating element, and the third heating element, the controller configured (i) to activate both the first heating element and the second heating element, such that first heating element and the second heating element generate heat simultaneously, during an accelerated preheating operation to preheat the air within the oven cavity and (ii) subsequently to deactivate one of the first heating element and the second heating element, while maintaining activation of the other of the first heating element and second heating element, after the third heating element is commanded to activate.

2. The cooking appliance of claim 1, wherein
the first heating element is at least partially exposed within the oven cavity near a ceiling of the oven liner.

3. The cooking appliance of claim 1, wherein
the second heating element is either (i) at least partially exposed within the oven cavity near a floor of the oven liner or (ii) disposed beneath the floor of the oven liner.

4. The cooking appliance of claim 1 further comprising:
a cooktop as the other cooking area, the cooktop comprising the third heating element.

5. The cooking appliance of claim 1 further comprising:
a second oven liner at least partially defining a second oven cavity as the other cooking area,
wherein, the third heating element is positioned to increase temperature of air within the second oven cavity.

6. The cooking appliance of claim 1, wherein
the third heating element is a magnetron.

7. The cooking appliance of claim 1, wherein
the controller activates both the first heating element and the second heating element for the accelerated preheating operation, upon a user issuing a command for a cooking operation and setting a temperature for the cooking operation, without the user having to command separately the accelerated preheating operation.

8. The cooking appliance of claim 1, wherein
the third heating element is activated for a brief period of time before the controller deactivates one of the first heating element and the second heating element.

9. The cooking appliance of claim 1, wherein
the controller is further configured to activate the third heating element after deactivating one of the first heating element and the second heating element.

10. The cooking appliance of claim 1, wherein
the controller is further configured to activate only one of the first heating element and the second heating element during a non-accelerated preheating operation to preheat the air within the oven cavity.

11. The cooking appliance of claim 1 further comprising:
a human-machine interface at which a user of the cooking appliance can command activation of the third heating element,
wherein, the controller is further in communication with the human-machine interface.

12. The cooking appliance of claim 11, wherein
the human-machine interface includes a display that is visible to a user, and
the controller is further configured to cause the display to display a first period of time remaining until completion of the accelerated preheating operation.

13. The cooking appliance of claim 12, wherein
in response to the third heating element being commanded to activate, the controller is further configured to cause the display to display a second period of time remaining until completion of a non-accelerated preheating operation to preheat the air within the oven cavity, the second period of time being greater than the first period of time.

14. The cooking appliance of claim 1, wherein
the cooking appliance has a power rating indicating a maximum amount of electrical power the cooking appliance is designed to consume during use, and
the cooking appliance does not exceed the power rating during the accelerated preheating operation but would exceed the power rating if the third heating element were activated simultaneously with the first heating element and the second heating element during the accelerated preheating operation.

15. The cooking appliance of claim 1, wherein
the controller activates both the first heating element and the second heating element for the accelerated preheating operation, upon a user issuing a command for a cooking operation and setting a temperature for the cooking operation and upon the user issuing a command for the accelerated preheating operation.

16. The cooking appliance of claim 1, wherein
while both the first heating element and the second heating element are activated, the first heating element encounters an electrical current that is greater than an electrical current that the second heating element encounters.

17. The cooking appliance of claim 1 further comprising:
a fan positioned to move the air within the oven cavity,
wherein, the controller is in further communication with the fan, and
wherein, the controller is further configured to activate simultaneously all of the first heating element, the second heating element, and the fan during the accelerated preheating operation.

18. The cooking appliance of claim 1, wherein
the controller does not lock a user out of activating the third heating element during the accelerated preheating operation.

19. A method of operating a cooking appliance comprising:
preheating an oven cavity of a cooking appliance with both a first heating element and a second heating element of a cooking appliance generating heat simultaneously and increasing temperature of air within the oven cavity of the cooking appliance; and
deactivating one of the first heating element and the second heating element, while maintaining activation of the other of the first heating element and the second heating element to continue to preheat the oven cavity, after a third heating element of the cooking appliance has been commanded to activate,
wherein, the third heating element is positioned to generate heat at another cooking area of the cooking appliance outside of the oven cavity.

20. The method of claim 19 further comprising:
activating the third heating element while maintaining activation of the other of the first heating element and the second heating element to continue to preheat the oven cavity.
